(19) United States
(12) Patent Application Publication
(10) Pub. No.: US 2026/0222067 A1
(43) Pub. Date: Jul. 30, 2026

(54) COMMUNICATION SYSTEM, CONTROL METHOD AND CENTRAL STATION

(71) Applicant: NTT, Inc., Tokyo (JP)

(72) Inventors: Yuta TAKAHASHI, Musashino-shi (JP); Yasuyoshi YAMAMOTO, Musashino-shi (JP); Takuto ARAI, Musashino-shi (JP); Yushi SHIRATO, Musashino-shi (JP); Hideki TOSHINAGA, Musashino-shi (JP); Daisei UCHIDA, Musashino-shi (JP); Naoki KITA, Musashino-shi (JP)

(73) Assignee: NTT, Inc., Tokyo (JP)

(21) Appl. No.: 19/143,671

(22) PCT Filed: Jan. 20, 2023
(86) PCT No.: PCT/JP2023/001687

§ 371 Date: Jun. 26, 2025

(51) Int. Cl. H04B 10/2575; H04B 7/024

(52) U.S. Cl. CPC H04B 10/2575; H04B 7/024

(57) ABSTRACT

One aspect of the present invention is a communication system including an aggregation station, and an extension station that communicates with the aggregation station by an analog RoF, in which the aggregation station includes a delay measurement signal transmission unit that transmits a delay measurement signal to the extension station, a delay measurement signal reception unit that receives the delay measurement signal folded back by the extension station, and a delay measurement unit that measures a delay time with respect to the extension station from a timing at which the delay measurement signal is transmitted and a timing at which the delay measurement signal is received, and the extension station includes a delay measurement signal folding unit that folds the delay measurement signal back to the aggregation station.

### TECHNICAL FIELD

The present invention relates to a communication system, a control method, and a technology of an aggregation station.

### BACKGROUND ART

Studies have been conducted to achieve flexible and economical radio area deployment by dividing a radio base station function into an aggregation station and an extension station by applying analog radio-over-fiber (RoF) and deploying a simple extension station (see Non Patent Literature 1).

In mobile communication after 4G, a time division duplex (TDD) system in which the same frequency is communicated in a time division manner in upstream communication and downstream communication is adopted in order to effectively use a frequency band, and it is essential to synchronize with a common time reference (global positioning system (GPS)) and to unify upstream and downstream TDD frame configurations in order to avoid radio wave interference with other service providers (see Non Patent Literature 2).

In general, precision time protocol (PTP) is used for high-precision time synchronization of mobile communication, but the extension station also requires to support PTP (Non Patent Literature 3). This will be specifically described with reference to FIGS. 10 and 11.

FIG. 10 illustrates a global navigation satellite system (GNSS), a grand master clock (GMC), a boundary clock (BC), and an ordinary clock (OC). Among them, BC is set as the aggregation station, and OC is set as the extension station. “M” in FIG. 10 indicates a master port, and “S” indicates a slave port.

The GMC is synchronized with the GNSS, which is a high-accuracy time source, and distributes high-accuracy time. The BC operates as a slave when viewed from the master, and operates as a master for the subnet. The OC includes one PTP port and operates as a master or a slave. Time synchronization is performed by performing message exchange according to the PTP sequence illustrated in FIG. 11 between the master port and the slave port. The BC and the OC implement highly accurate measurement of a delay time by including an operation of canceling an internal delay of an apparatus by a PIP packet.

In FIG. 11, the master transmits the Sync message, and the slave receives a Sync message at time t2. The master generates a Follow_up message and informs the slave of the time t1 at which the Sync message was sent. The slave transmits Delay_Req. At this time, the transmission time is t3. The master transmits Delay_Resp including the time t4 at which Delay_Req has been received. The slave that has received Delay_Resp corrects the time shift based on t1, t2, t3, and t4.

Specifically, first, a delay of one-way communication is ((t4−t1)−(t3−t2))/2. Therefore, the slave calculates (t2−t1)−((t4−t1)−(t3−t2))/2 as the offset from the master, and corrects its own time using this.

### CITATION LIST

### Non Patent Literature

Non Patent Literature 1: Kota Ito, Mizuki Suga, Yuji Shirato, Naoki Kita, Takeshi Onizawa, “Efficiently Accommodating High-frequency-band Wireless Systems by Using Analog Radio-over-fiber”, NTT Technical Journal, 32(3), 15-17, 2020.

Non Patent Literature 2: Kaoru Arai, Makoto Murakami, “High-precision time synchronization technology that enables low-latency, high-capacity communications in the 5G and Beyond 5G era”

Non Patent Literature 3:“IEC/IEEE International Standard Precision Clock Synchronization Protocol for Networked Measurement and Control Systems,” in IEC/IEEE 61588-2021, vol., no., pp. 1-504, 8 Jun. 2021, doi: 10.1109/IEEESTD.2021.9456762.

### SUMMARY OF INVENTION

### Technical Problem

In order to measure the delay time, the PTP sequence is essential, and dedicated hardware supporting the PTP function is also required in the extension station. However, since this is premised on the digital RoF, this cannot be directly applied to the analog RoF. In the case of application to the analog RoF, it is required to add a function of performing digital processing on the extension station side, and there is a problem that the function and configuration of the extension station become complicated.

In view of the above circumstances, an object of the present invention is to provide a technique capable of performing delay measurement between an aggregation station and an extension station with a simple configuration of the extension station.

### Solution to Problem

An aspect of the present invention is a communication system including an aggregation station, and an extension station that communicates with the aggregation station by an analog radio-over-fiber (RoF), in which the aggregation station includes a delay measurement signal transmission unit that transmits a delay measurement signal to the extension station, a delay measurement signal reception unit that receives the delay measurement signal folded back by the extension station, and a delay measurement unit that measures a delay time with respect to the extension station from a timing at which the delay measurement signal is transmitted and a timing at which the delay measurement signal is received, and the extension station includes a delay measurement signal folding unit that folds the delay measurement signal back to the aggregation station.

An aspect of the present invention is a control method in a communication system including an aggregation station and an extension station that communicates with the aggregation station by an analog radio-over-fiber (RoF), in which the aggregation station includes a delay measurement signal transmission step of transmitting a delay measurement signal to the extension station, a delay measurement. signal reception step of receiving the delay measurement signal folded back by the extension station, and a delay measurement step of measuring a delay time from a timing at which the delay measurement signal is transmitted and a timing at which the delay measurement signal is received, and the extension station includes a delay measurement signal folding step of folding back the delay measurement signal to the aggregation station.

An aspect of the present invention is an aggregation station in a communication system including an aggregation station and an extension station that communicates with the aggregation station by an analog radio-over-fiber (RoF), the station including a delay measurement signal transmission unit that transmits a delay measurement signal to the extension station, a delay measurement signal reception unit that receives the delay measurement signal folded back by the extension station, and a delay measurement unit that measures a delay time from a timing at which the delay measurement signal is transmitted and a timing at which the delay measurement signal is received.

### Advantageous Effects of Invention

According to the present invention, it is possible to perform delay measurement between the aggregation station and the extension station with a simple configuration of the extension station.

### BRIEF DESCRIPTION OF DRAWINGS

FIG. 1 A block diagram illustrating a configuration of a communication system.

FIG. 2 A diagram illustrating a detailed configuration of an aggregation station and an extension station.

FIG. 3 A diagram illustrating reception power of a folded delay measurement signal.

FIG. 4 A sequence diagram illustrating a flow of processing of the communication system.

FIG. 5 A flowchart illustrating a flow of processing of an aggregation station.

FIG. 6 A diagram illustrating a configuration in a case where the aggregation station and the extension station are connected in a cascade configuration.

FIG. 7 A block diagram illustrating a configuration of a communication system including a relay station and the like.

FIG. 8 A diagram illustrating a detailed configuration of a relay station and a relay extension station.

FIG. 9 A diagram illustrating a configuration of each station in a configuration in which a relay station is not synchronized with a GNSS.

FIG. 10 A diagram for illustrating a conventional technique.

FIG. 11 A diagram for illustrating a conventional technique.

### DESCRIPTION OF EMBODIMENTS

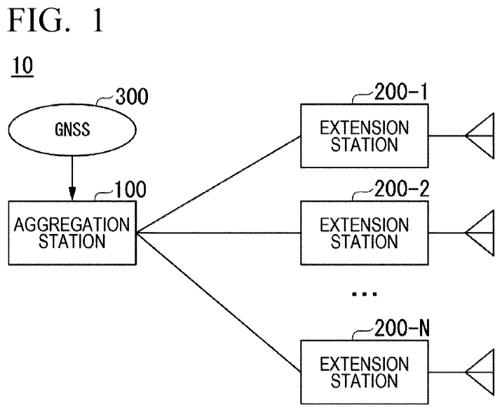

FIG. 1 is a block diagram illustrating a configuration of a communication system 10. The communication system 10 includes an aggregation station 100, extension stations 200-1, 200-2, 1 and 200-N (N is an integer of 1 or more), and a global navigation satellite system (GNSS) 300. In the following description, each of the extension stations 200-1, 200-2, and 200-N will be referred to as an extension station 200 unless otherwise distinguished. In addition, the configuration illustrated in FIG. 1 illustrates a configuration in a case where the aggregation station 100 and the extension station 200 are connected in a star configuration.

The aggregation station 100 and the extension station 200 are connected by an optical fiber. In addition, the aggregation station 100 and the extension station 200 communicate with each other by analog radio-over-fiber (RoF). The aggregation station 100 is synchronized with the GNSS 300 which is a high-accuracy time source. The extension station 200 includes an antenna unit for wireless communication.

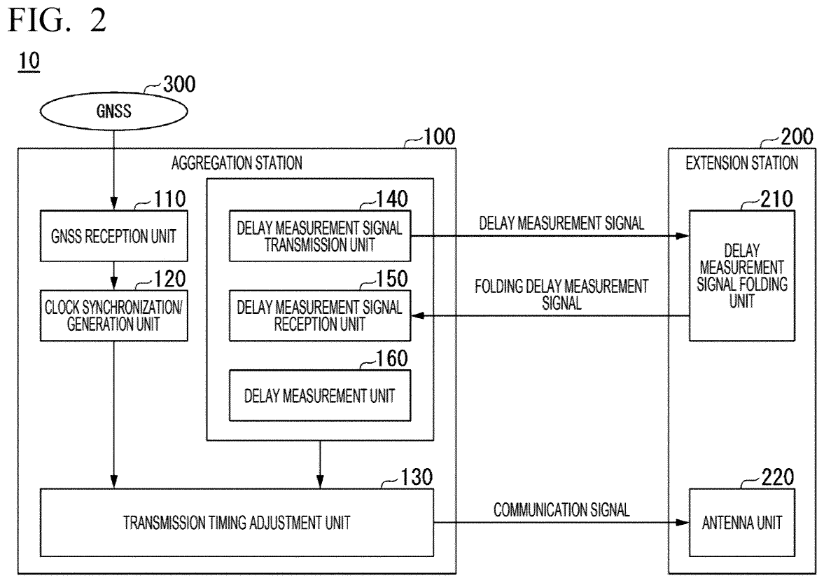

Detailed configurations of the aggregation station 100 and the extension station 200 will be described. FIG. 2 is a diagram illustrating a detailed configuration of the aggregation station 100 and the extension station 200. In FIG. 2, the aggregation station 100 includes a GNSS reception unit 110, a clock synchronization/generation unit 120, a transmission timing adjustment unit 130, a delay measurement signal transmission unit 140, a delay measurement signal reception unit 150, and a delay measurement unit 160.

The GNSS reception unit 110 receives a GNSS signal from the GNSS 300 and outputs the GNSS signal to the clock synchronization/generation unit 120. The clock synchronization/generation unit 120 generates a clock in synchronization with the GNSS signal. The delay measurement signal transmission unit 140 transmits a delay measurement: signal to the extension station 200. The delay measurement signal reception unit 150 receives the delay measurement signal folded back by the extension station 200. The delay measurement unit 160 measures the delay time with respect to the extension station 200 from the timing at which the delay measurement signal is transmitted and the timing at which the delay measurement signal is received. In a case where there are a plurality of extension stations 200, the delay measurement unit 160 identifies each of the extension stations 200 and associates the measured delay amount.

When the timing at which the delay measurement signal is transmitted is T1 and the timing at which the delay measurement signal is received is T2, the delay measurement unit 160 measures T2−T1 as a delay time. Note that the aggregation station 100 may hold delay information indicating a delay occurring inside the aggregation station 100 and the extension station 200 in advance. In this case, the delay measurement unit 160 may measure the delay time in consideration of the delay information.

Furthermore, in the aggregation station 100, a circulator or the like may be used for transmission/reception separation of a delay measurement signal and a downlink (hereinafter, also referred to as “DL”) signal and an uplink (hereinafter, also referred to as “UL”) of the folded delay measurement signal. In addition, the delay measurement signal may be a digital signal (such as a packet) or an analog signal.

The transmission timing adjustment unit 130 adjusts the downlink transmission timing transmitted by the extension station 200 based on the delay time measured by the delay measurement unit 160. Specifically, based on the delay time measured by the delay measurement unit 160, the transmission timing adjustment unit 130 adjusts the downlink transmission timings of the antenna units of the extension stations 200 to the same timing from the clock signal generated by the clock synchronization/generation unit 120.

Next, the extension station 200 will be described. The extension station 200 includes a delay measurement signal folding unit 210 and an antenna unit 220. The delay measurement signal folding unit 210 folds the delay measurement signal transmitted from the aggregation station 100 back to the aggregation station 100. Note that the signal folding of the extension station 200 may be performed inside the extension station, or an arbitrary wavelength may be reflected at the input terminal of the extension station 200. In addition, a fiber Bragg grating or a thin film filter may be used to fold the signal (transmit communication wavelength and reflect wavelength of delay measurement signal).

The antenna unit 220 transmits a communication signal from the aggregation station 100 as a radio signal. In a case where the communication signal in the optical fiber is the IF signal, the up-conversion is performed on the DL signal, and the down-conversion is performed on the UL signal.

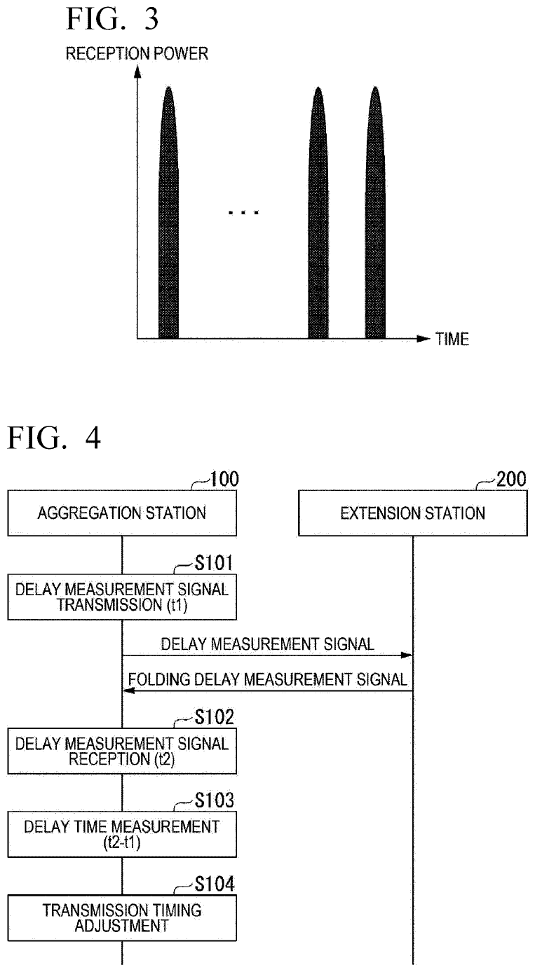

In the embodiment described above, when the delay measurement signals folded back from the plurality of extension stations 200 interfere with each other, the folded extension stations 200 cannot be identified. This interference will be described. First, a case where the delay measurement signals have the same wavelength and the optical fiber lengths of the aggregation station 100 and the extension station 200 are different from each other will be described. FIG. 3 is a diagram illustrating reception power of a folded delay measurement signal. In the graph illustrated in FIG. 3, the vertical axis represents the reception power of the delay measurement signal folded back, and the horizontal axis represents time. As illustrated in FIG. 3, even if the delay measurement signals have the same wavelength, the optical fiber lengths are different from each other, so that the folded delay measurement signals do not interfere with each other.

As described above, in a case where the optical fiber lengths are different from each other, it is possible to measure the delay time and identify the extension station 200 by intentionally designing the optical fiber lengths of the aggregation station 100 and each extension station 200. Note that “intentionally designing the optical fiber length” means, for example, designing such that the optical fiber length with the extension station 200-1 is the shortest and the optical fiber length with the extension station 200-N is the longest.

The optical fiber length with the extension station 200 may be changed, or a delay different for each analog RoF path may be set by a delay device. In this case, the aggregation station 100 may identify each of the extension stations 200 from the difference between the measured delay times, and may perform delay measurement individually. In order to avoid interference of the delay measurement signals folded back from the plurality of extension stations 200 at this time, a short signal waveform, for example, a tone burst signal or a narrow pulse wave may be used. In a case where the tone burst signal is used, the aggregation station 100 detects the folded signal by the power detector.

As a configuration for identifying each of the extension stations 200, a configuration may be employed in which the frequency of the delay measurement signal transmitted by the aggregation station 100 for each of the extension stations 200 is shifted by Δf for measurement. The delay measurement signal shifted by Δf may be transmitted by subcarrier multiplexing (SCM) or the like transmitted at one wavelength of light.

In this case, the frequency allocated in advance in the extension station 200 is returned to the aggregation station 100 without using the optical filter. Examples of a method of returning the delay measurement signal in the extension station 200 include a method of newly generating a return signal when a signal of a frequency assigned to the own extension station 200 is received, and a method of returning only a signal of a frequency assigned to the own station via an electric filter corresponding to a frequency assigned to the own station.

Furthermore, examples of the configuration for identifying the extension station 200 include a method of measuring the optical transmission wavelength band separately by wavelength division multiplexing (WDM) or the like, and a method of measuring the optical transmission wavelength band separately by a switching switch or the like.

As described above, in a case of communicating with the plurality of extension stations 200, the delay measurement unit 260 may identify the extension station that has returned the delay measurement signal based on the fiber length of the optical fiber connecting each of the plurality of extension stations 200 and the aggregation station 100, the frequency of the signal communicating with each of the plurality of extension stations 200, or the optical transmission band of the signal communicating with each of the plurality of extension stations 200.

On the other hand, when the fiber length of the optical fiber connecting each of the plurality of extension stations 200 and the aggregation station 100 is the same in all the extension stations 200 or substantially the same in all the extension stations 200, the delay time measured for one extension station 200 may be set as the delay time for all the extension stations 200. That is, since it is only required to measure the delay time of only one path in the analog RoF section, the processing required for the measurement can be simplified.

When the fiber lengths of the optical fibers connecting each of the plurality of extension stations 200 and the aggregation station 100 are the same in all the extension stations 200 or are substantially the same in all the extension stations 200, even in a case of an environment in which the characteristics of the plurality of optical fibers are similarly changed due to an influence of an external factor, it is only required to measure the delay time of only one path in the analog RoF section.

In a case where the influence of external factors on the optical fiber characteristics is limited or it is not required to strictly unify the transmission timings, the aggregation station 100 may have a function of measuring, recording, and holding the delay time for each of the extension stations 200 in advance. In addition, a function of adjusting a transmission timing to each extension station from the recorded delay time may be provided.

A flow of processing of the above-described communication system 10 will be described using a sequence diagram. FIG. 4 is a sequence diagram illustrating a flow of processing of the communication system 10. In FIG. 4, the aggregation station 100 transmits a delay measurement signal to the extension station 200 (Step S101). The time at the time of transmission is t1. The transmitted delay measurement signal is folded back by the extension station 200. The aggregation station 100 receives the folding delay measurement signal (Step S102). The time at the time of reception is t2. The aggregation station 100 obtains (t2−t1) to measure the delay time (Step S103). The aggregation station 100 adjusts the downlink transmission timing to be transmitted by the extension station 200 based on the measured delay time (Step S104).

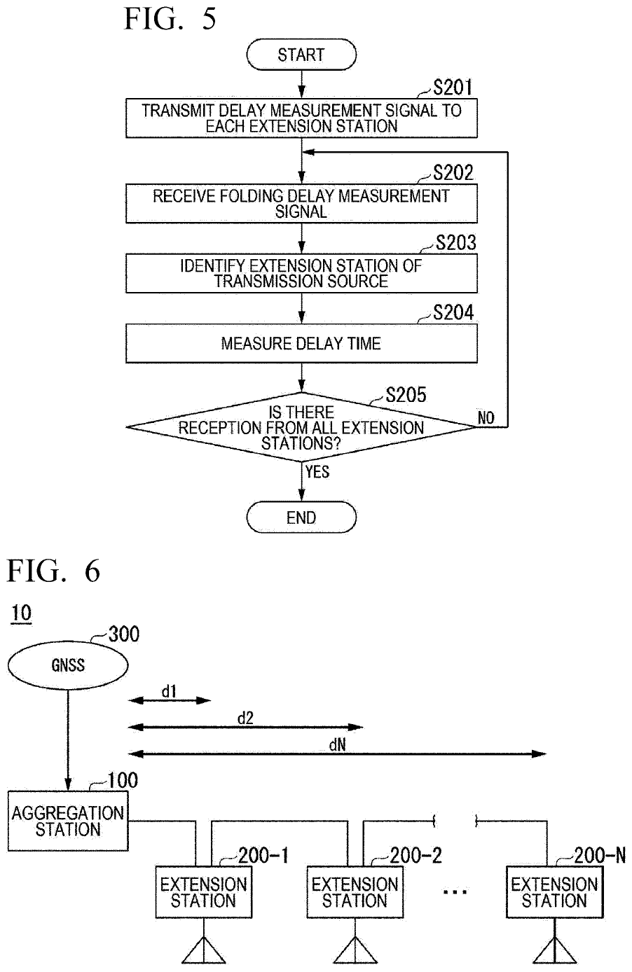

The processing illustrated in FIG. 4 is performed on all the extension stations 200. The aggregation station 100 in FIG. 4 described above in a case where there is a plurality of the extension stations 200 will be described. FIG. 5 is a flowchart illustrating a flow of processing of the aggregation station 100. In FIG. 5, the aggregation station 100 transmits a delay measurement signal to each extension station (Step S201). The aggregation station 100 receives the folding delay measurement signal (Step S202). The aggregation station 100 identifies the extension station 200 that is the transmission source of the received folding delay measurement signal (Step S203), and measures the delay time (Step S204). Next, it is determined whether or not the folding delay measurement signals have been received from all the extension stations 200 (Step S205).

In a case where the folding delay measurement signals have not been received from all the extension stations 200 (Step S205: NO), the processing returns to Step S202. On the other hand, in a case where the folding delay measurement signals have been received from all the extension stations 200 (Step S205: YES), the processing related to the delay time ends. Thereafter, as described in FIG. 4, the aggregation station 100 adjusts the downlink transmission timing transmitted by the extension station 200 based on the measured delay time.

According to the embodiment described above, it is possible to perform delay measurement between the aggregation station and the extension station with a simple configuration of the extension station. Note that, in the above-described embodiment, the case of being connected in the star configuration has been described. The configuration illustrated in FIG. 6 illustrates a configuration in a case where the aggregation station 100 and the extension station 200 are connected in a cascade configuration. In FIG. 6, the aggregation station 100 and the GNSS 300 are connected. In addition, the aggregation station 100 is connected to the extension station 200-1.

The extension station 200-1 is connected to the extension station 200-2. In general, the extension station 200-(k-1) is connected to the extension station 200-k (k is an integer from 2 to N).

In addition, in the configuration illustrated in FIG. 6, the optical fiber length between the aggregation station 100 and the extension station 200-n (n is an integer of 1 to N) is dn, and di<dj is established (i and j are integers and i<j). Therefore, in a case where the arrival order of the folding delay measurement signal is m, the transmission source can be identified as the extension station 200-m (m is an integer from 1 to N).

Note that the configuration of the aggregation station 100 and the configuration of the extension station 200 in FIG. 6 are the same as the configuration illustrated in FIG. 2.

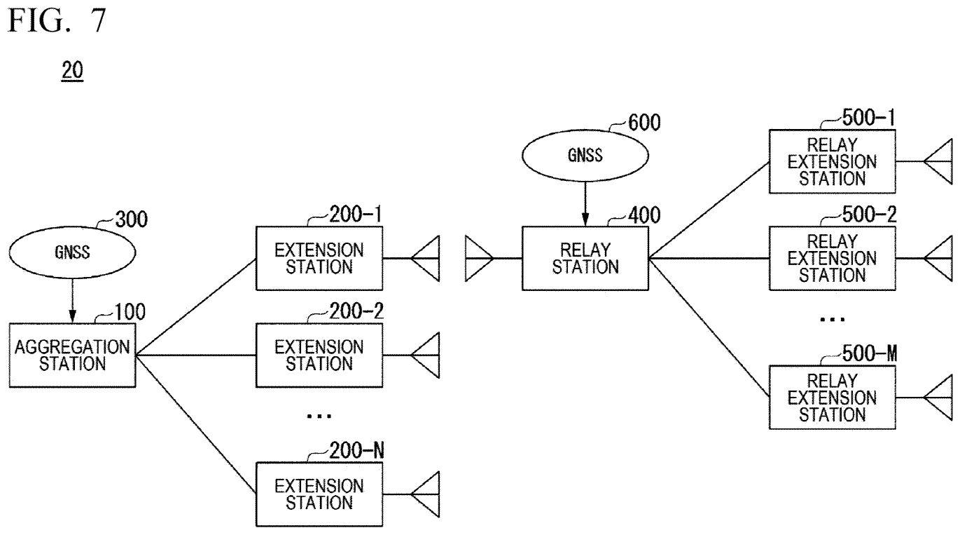

Next, a configuration example of a communication system including a relay station and the like will be described. FIG. 7 is a block diagram illustrating a configuration of a communication system 20 including a relay station and the like. The communication system 20 includes the aggregation station 100, the extension stations 200-1, 200-2, and 200-N (N is an integer of 1 or more), GNSSs 300 and 600, the relay station 400, and relay extension stations 500-1, 500-2, . . . , and 500-M (M is an integer of 1 or more). In the following description, each of the relay extension stations 500-1, 500-2, and 500-M is referred to as a relay extension station 500 unless otherwise distinguished.

The aggregation station 100 and the extension station 200 are connected by an optical fiber. In addition, the aggregation station 100 and the extension station 200 communicate by the analog RoF. The aggregation station 100 is synchronized with the GNSS 300 which is a high-accuracy time source. The extension station 200 includes an antenna unit for wireless communication.

The relay station 400 and the relay extension station 500 are connected by an optical fiber. In addition, the relay station 400 and the relay extension station 500 communicate by the analog RoF. The relay station 400 is synchronized with a GNSS 600 which is a high-accuracy time source. The relay station 400 and the relay extension station 500 include an antenna unit for wireless communication.

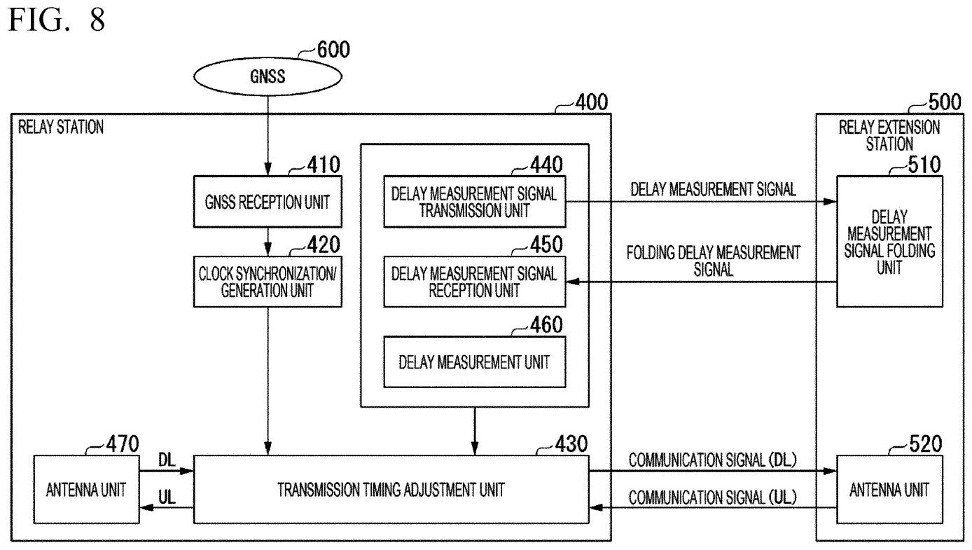

Note that the configuration of the aggregation station 100 and the configuration of the extension station 200 are the same as the configuration illustrated in FIG. 2. Detailed configurations of the relay station 400 and the relay extension station 500 will be described. FIG. 8 is a diagram illustrating a detailed configuration of the relay station 400 and the relay extension station 500. In FIG. 8, the relay station 400 includes a GNSS reception unit 410, a clock synchronization/generation unit 420, a transmission timing adjustment unit 430, a delay measurement signal transmission unit 440, a delay measurement signal reception unit 450, a delay measurement unit 460, and an antenna unit 470.

The GNSS reception unit 410 receives a GNSS signal from the GNSS 600 and outputs the GNSS signal to the clock synchronization/generation unit 420. The clock synchronization/generation unit 420 generates a clock in synchronization with the GNSS signal. The delay measurement signal transmission unit 440 transmits a delay measurement signal to the relay extension station 500. The delay measurement signal reception unit 450 receives the delay measurement signal folded back by the relay extension station 500. The delay measurement unit 460 measures the delay time with respect to the relay extension station 500 from the timing at which the delay measurement signal is transmitted and the timing at which the delay measurement signal is received. In a case where there are a plurality of relay extension stations 500, the delay measurement unit 460 identifies each relay extension station 500 and associates the measured delay amount.

When the timing at which the delay measurement signal is transmitted is T1 and the timing at which the delay measurement signal is received is T2, the delay measurement unit 460 measures T2−T1 as a delay time. Note that the relay station 400 may hold delay information indicating a delay occurring inside the relay station 400 and the relay extension station 500 in advance. In this case, the delay measurement unit 460 may measure the delay time in consideration of the delay information.

The transmission timing adjustment unit 430 adjusts the downlink transmission timing transmitted by the relay extension station 500 based on the delay time measured by the delay measurement unit 460. Specifically, based on the delay time measured by the delay measurement unit 460, the transmission timing adjustment unit 430 adjusts the downlink transmission timing of the antenna units of the relay extension stations 500 to the same timing from the clock signal generated by the clock synchronization/generation unit 420. The antenna unit 470 is an antenna for performing wireless communication with the extension station 200.

Next, the relay extension station 500 will be described. The relay extension station 500 includes a delay measurement signal folding unit 510 and an antenna unit 520. The delay measurement signal folding unit 510 returns the delay measurement signal transmitted from the relay station 400 to the relay station 400. Note that the signal folding of the relay extension station 500 may be performed inside the relay extension station, or an arbitrary wavelength may be reflected at the input terminal of the relay extension station 500. In addition, a fiber Bragg grating or a thin film filter may be used to fold the signal (transmit communication wavelength and reflect wavelength of delay measurement signal).

The antenna unit 520 transmits a communication signal from the relay station 400 as a radio signal. In a case where the communication signal in the optical fiber is the IF signal, the up-conversion is performed on the DL signal, and the down-conversion is performed on the UL signal.

In the communication system 20, in a case where the relay station 400 and the relay extension station 500 have different optical fiber lengths, it is possible to measure the delay time and identify the relay extension station 500 by intentionally designing the optical fiber lengths of the relay station 400 and each relay extension station 500. Note that “intentionally designing the optical fiber length” means, for example, designing such that the optical fiber length with the relay extension station 500-1 is the shortest and the optical fiber length with the relay extension station 500-M is the longest.

The optical fiber length with the relay extension station 500 may be changed, or a delay device may set a different delay for each analog RoF path. In this case, the relay station 400 may identify each relay extension station 500 from the difference between the measured delay times, and perform delay measurement individually. At this time, a short signal waveform, for example, a tone burst signal or a pulse wave having a narrow width may be used in order to avoid interference of the delay measurement signals folded back from the plurality of relay extension stations 500. In a case where the tone burst signal is used, the relay station 400 detects the folded signal by the power detector.

As a configuration for identifying each relay extension station 500, a configuration may be employed in which the frequency of the delay measurement signal transmitted by the relay station 400 for each relay extension station 500 is shifted by Af for measurement. The delay measurement signal shifted by Af may be transmitted by subcarrier multiplexing (SCM) or the like transmitted at one wavelength of light.

In this case, the optical filter is not used, and the frequency allocated in advance in the relay extension station 500 is returned to the relay station 400. Examples of a method of returning the delay measurement signal in the relay extension station 500 include a method of newly generating a return signal when a signal of a frequency assigned to the own relay extension station 500 is received, and a method of returning only a signal of a frequency assigned to the own station via an electric filter corresponding to the frequency assigned to the own station.

Furthermore, examples of the configuration for identifying the relay extension station 500 include a method of performing measurement by dividing an optical transmission wavelength band by wavelength division multiplexing (WDM) or the like, and a method of performing measurement by dividing the optical transmission wavelength band by time using a switching switch or the like.

As described above, in a case of communicating with the plurality of relay extension stations 500, the delay measurement unit 260 may identify an extension station that has folded back the delay measurement signal based on a fiber length of an optical fiber connecting each of the plurality of relay extension stations 500 and the relay station 400, a frequency of a signal communicating with each of the plurality of relay extension stations 500, or an optical transmission band of a signal communicating with each of the plurality of relay extension stations 500.

On the other hand, when the fiber length of the optical fiber connecting each of the plurality of relay extension stations 500 and the relay station 400 is the same in all the relay extension stations 500 or substantially the same in all the relay extension stations 500, the delay time measured for one relay extension station 500 may be used as the delay time for all the relay extension stations 500. That is, since it is only required to measure the delay time of only one path in the analog RoF section, the processing required for the measurement can be simplified.

Note that, when the fiber lengths of the optical fibers connecting each of the plurality of relay extension stations 500 and the relay station 400 are the same in all the relay extension stations 500 or are substantially the same in all the relay extension stations 500, even in a case of an environment in which the characteristics of the plurality of optical fibers are similarly changed due to the influence of an external factor, it is only required to measure the delay time of only one path in the analog RoF section.

In a case where the influence of an external factor on the optical fiber characteristics is limited or strict integration of the transmission timings is unnecessary, the relay station 400 may have a function of measuring, recording, and holding the delay time for each relay extension station 500 in advance. In addition, a function of adjusting the transmission timing to each relay extension station from the recorded delay time may be provided.

According to the embodiment described above, the delay measurement between the relay station and the relay extension station can be performed with a simple configuration of the relay station.

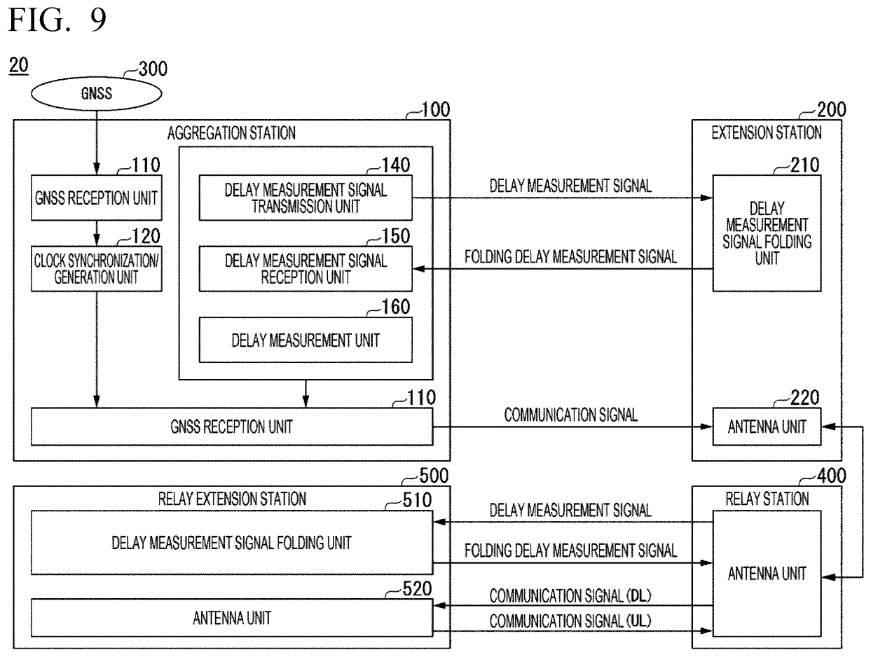

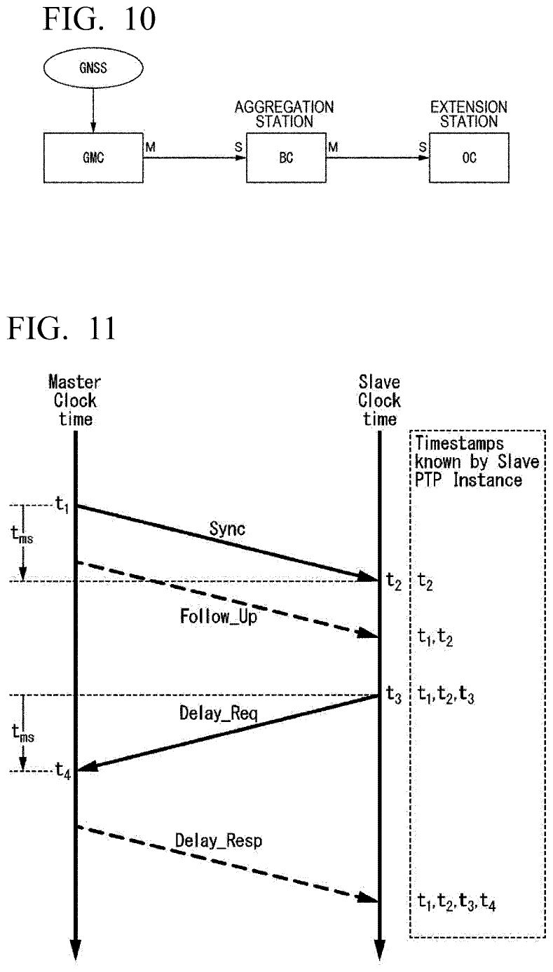

In the configuration illustrated in FIG. 8 described above, the relay station 400 is synchronized with the GNSS 600, but a configuration in which the relay station 400 is not synchronized with the GNSS 600 will be described. FIG. 9 is a diagram illustrating a configuration of each station in a configuration in which the relay station 400 is not synchronized with the GNSS 600.

In FIG. 9, the aggregation station 100 includes a GNSS reception unit 110, a clock synchronization/generation unit 120, a transmission timing adjustment unit 130, a delay measurement signal transmission unit 140, a delay measurement signal reception unit 150, and a delay measurement unit 160.

The GNSS reception unit 110 receives a GNSS signal from the GNSS 300 and outputs the GNSS signal to the clock synchronization/generation unit 120. The clock synchronization/generation unit 120 generates a clock in synchronization with the GNSS signal. The delay measurement signal transmission unit 140 transmits a delay measurement. signal to the extension station 200. The delay measurement signal reception unit 150 receives the delay measurement signal folded back by the extension station 200. The delay measurement unit 160 measures the delay time with respect to the extension station 200 and the relay extension station 500 from the timing at which the delay measurement signal is transmitted and the timing at which the delay measurement signal is received. In a case where there are a plurality of extension stations 200, the delay measurement unit 160 identifies each of the extension stations 200 and the relay extension station 500, and associates the measured delay amount.

When the timing at which the delay measurement signal is transmitted is T1 and the timing at which the delay measurement signal is received is T2, the delay measurement unit 160 measures T2−T1 as a delay time. Note that the aggregation station 100 may hold delay information indicating a delay occurring inside the aggregation station 100, the extension station 200, the relay station 400, and the relay extension station 500 in advance. In this case, the delay measurement unit 160 may measure the delay time in consideration of the delay information.

Furthermore, in the aggregation station 100, a circulator or the like may be used for transmission/reception separation of the DL signal and the UL of the delay measurement signal and the folded delay measurement signal. In addition, the delay measurement signal may be a digital signal (such as a packet) or an analog signal.

The transmission timing adjustment unit 130 adjusts the downlink transmission timing transmitted by the extension station 200 and the relay extension station 500 based on the delay time measured by the delay measurement unit 160. Specifically, based on the delay time measured by the delay measurement unit 160, the transmission timing adjustment unit 130 adjusts the downlink transmission timings of the antenna units of each of the extension stations 200 and the relay extension station 500 to the same timing from the clock signal generated by the clock synchronization/generation unit 120.

Next, the extension station 200 will be described. The extension station 200 includes a delay measurement signal folding unit 210 and an antenna unit 220. The delay measurement signal folding unit 210 folds the delay measurement signal transmitted from the aggregation station 100 back to the aggregation station 100. Note that the signal folding of the extension station 200 may be performed inside the extension station, or an arbitrary wavelength may be reflected at the input terminal of the extension station 200. In addition, a fiber Bragg grating or a thin film filter may be used to fold the signal (transmit communication wavelength and reflect wavelength of delay measurement signal).

The antenna unit 220 transmits a communication signal from the aggregation station 100 as a radio signal. In a case where the communication signal in the optical fiber is the IF signal, the up-conversion is performed on the DL signal, and the down-conversion is performed on the UL signal.

In FIG. 9, the relay station 400 and the relay extension station 500 are connected by an optical fiber. The relay station 400 includes the antenna unit 470. The antenna unit 470 is an antenna for performing wireless communication with the extension station 200. In addition, the relay station 400 and the relay extension station 500 communicate by the analog RoF. The relay station 400 transmits the delay measurement signal transmitted from the aggregation station 100 to the relay extension station 500. The relay station 400 transmits the folding delay measurement signal received from the relay extension station 500 to the extension station 200.

The relay extension station 500 includes a delay measurement signal folding unit 510 and an antenna unit 520. The delay measurement signal folding unit 510 returns the delay measurement signal transmitted from the relay station 400 to the relay station 400. Note that the signal folding of the relay extension station 500 may be performed inside the relay extension station, or an arbitrary wavelength may be reflected at the input terminal of the relay extension station 500. In addition, a fiber Bragg grating or a thin film filter may be used to fold the signal (transmit communication wavelength and reflect wavelength of delay measurement signal).

The antenna unit 520 transmits a communication signal from the relay station 400 as a radio signal. In a case where the communication signal in the optical fiber is the IF signal, the up-conversion is performed on the DL signal, and the down-conversion is performed on the UL signal.

In the case of the configuration illustrated in FIG. 9, the aggregation station 100 adjusts the downlink transmission timing transmitted by the extension station 200 and the relay extension station 500 based on the delay time measured by the delay measurement unit 160.

According to the embodiment described above, it is possible to measure the delay between the extension station and the relay extension station with a simple configuration of the aggregation station.

The clock synchronization/generation units 120 and 420, the transmission timing adjustment units 130 and 430, the delay measurement signal transmission units 140 and 440, the delay measurement signal reception units 150 and 450, and the delay measurement units 160 and 460 may be configured using a processor such as a central processing unit (CPU) and a memory. In this case, the clock synchronization/generation units 120 and 420, the transmission timing adjustment units 130 and 430, the delay measurement signal transmission units 140 and 440, the delay measurement signal reception units 150 and 450, and the delay measurement units 160 and 460 function as the clock synchronization/generation units 120 and 420, the transmission timing adjustment units 130 and 430, the delay measurement signal transmission units 140 and 440, the delay measurement signal reception units 150 and 450, and the delay measurement units 160 and 460 when the processor executes a program. All or some of the functions of the clock synchronization/generation units 120 and 420, the transmission timing adjustment units 130 and 430, the delay measurement signal transmission units 140 and 440, the delay measurement signal reception units 150 and 450, and the delay measurement units 160 and 460 may be implemented using hardware such as an application specific integrated circuit (ASIC), a programmable logic device (PLD), or a field programmable gate array (FPGA). The above program may be recorded in a computer-readable recording medium. The computer-readable recording medium is, for example, a portable medium such as a flexible disk, a magneto-optical disc, a ROM, a CD-ROM, or a semiconductor storage device (e.g. solid state drive (SSD) ) or a storage device such as a hard disk or a semiconductor storage device built in a computer system. The above program may be transmitted via a telecommunication line.

While the embodiment of the present invention has been described in detail with reference to the drawings, specific configurations are not limited to this embodiment, and include designs and the like without departing from the spirit of the present invention.

### INDUSTRIAL APPLICABILITY

The present invention is applicable to a communication system that performs communication using an analog RoF.

### REFERENCE SIGNS LIST

10, 20 Communication system
100 Aggregation station
110 Reception unit
120 Clock synchronization/generation unit
130 Transmission timing adjustment unit
140 Delay measurement signal transmission unit
150 Delay measurement signal reception unit
160 Delay measurement unit
200, 200-1, 200-2, 200-k, 200-N Extension station
210 Delay measurement signal folding unit
220 Antenna unit
260 Delay measurement unit
400 Relay station
410 Reception unit
420 Clock synchronization/generation unit
430 Transmission timing adjustment unit
440 Delay measurement signal transmission unit
450 Delay measurement signal reception unit
460 Delay measurement unit
470 Antenna unit
500, 500-1, 500-2, 500-M Relay extension station
510 Delay measurement signal folding unit
520 Antenna unit

1. A communication system comprising:
an aggregation station; and
an extension station that communicates with the aggregation station by an analog radio-over-fiber (RoF), wherein
the aggregation station includes
a delay measurement signal transmission circuitry that transmits a delay measurement signal to the extension station,
a delay measurement signal reception circuitry that receives the delay measurement signal folded back by the extension station, and
a delay measurement circuitry that measures a delay time with respect to the extension station from a timing at which the delay measurement signal is transmitted and
a timing at which the delay measurement signal is received, and the extension station includes
a delay measurement signal folding circuitry that folds the delay measurement signal back to the aggregation station.

2. The communication system according to claim 1, wherein the aggregation station includes an adjustment circuitry that adjusts a downlink transmission timing transmitted by the extension station based on a delay time measured by the delay measurement circuitry.

3. The communication system according to claim 1, wherein in a case of performing communication with a plurality of the extension stations, when fiber lengths of optical fibers connecting each of the plurality of extension stations and the aggregation station are the same in all the extension stations or are substantially the same in all the extension stations, the delay measurement circuitry sets a delay time measured for one of the extension stations as a delay time for all the extension stations.

4. The communication system according to claim 1, wherein in a case of performing communicating with a plurality of the extension stations, the delay measurement circuitry identifies the extension station that has folded the delay measurement signal, based on a fiber length of an optical fiber connecting each of the plurality of extension stations and the aggregation station, a frequency of a signal communicating with each of the plurality of extension stations, or an optical transmission band of a signal communicating with each of the plurality of extension stations.

5. The communication system according to claim 1, wherein the aggregation station and the extension station are connected in a star type or a cascade type.

6. The communication system according to claim 1, comprising:
a relay station that performs wireless communication with the extension station; and
a relay extension station that performs communication with the relay station by an analog RoF, wherein
the relay station includes
another delay measurement signal transmission circuitry that transmits the delay measurement signal to the relay extension station,
another delay measurement signal reception circuitry that receives the delay measurement signal folded back by the relay extension station, and
another delay measurement circuitry that measures a delay time from a timing at which the delay measurement signal is transmitted and a timing at which the delay measurement signal is received, and
the relay extension station includes
another delay measurement signal folding circuitry that folds the delay measurement signal back to the relay station.

7. A control method in a communication system including an aggregation station and an extension station that communicates with the aggregation station by an analog radio-over-fiber (RoF), wherein
the control method by the aggregation station includes
a delay measurement signal transmission step of transmitting a delay measurement signal to the extension station,
a delay measurement signal reception step of receiving the delay measurement signal folded back by the extension station; and
a delay measurement step of measuring a delay time from a timing at which the delay measurement signal is transmitted and a timing at which the delay measurement signal is received, and
the control method by the extension station includes
a delay measurement signal folding step of folding back the delay measurement signal to the aggregation station.

8. An aggregation station in a communication system including an aggregation station and an extension station that communicates with the aggregation station by an analog radio-over-fiber (RoF), the station comprising:
a delay measurement signal transmission circuitry that transmits a delay measurement signal to the extension station;
a delay measurement signal reception circuitry that receives the delay measurement signal folded back by the extension station; and
a delay measurement circuitry that measures a delay time from a timing at which the delay measurement signal is transmitted and a timing at which the delay measurement signal is received.
